(19) United States
(12) Patent Application Publication
(10) Pub. No.: US 2026/0160557 A1
(43) Pub. Date: Jun. 11, 2026

(54) METHOD, APPARATUS, ELECTRONIC DEVICE AND STORAGE MEDIUM FOR ASSISTED VOICE NAVIGATION

(71) Applicant: Beijing Zitiao Network Technology Co., Ltd., Haidian District, Beijing (CN)

(72) Inventors: Jianlong Zhang, Beijing (CN); Mingyuan Wang, Beijing (CN); Lishu Luo, Beijing (CN); Yi Fu, Beijing (CN); Chao Long, Beijing (CN); Liyue Wang, Beijing (CN); Peitao Hu, Beijing (CN)

(21) Appl. No.: 19/127,202

(22) PCT Filed: Nov. 3, 2023
(86) PCT No.: PCT/CN2023/129805

§ 371 Date: May 5, 2025

(30) Foreign Application Priority Data
Nov. 11, 2022 (CN) 202211415769.0

(51) Int. Cl. G01C 21/20; G06T 7/73; G06T 15/20; G06V 10/25; G06V 20/20; G09B 21/00

(52) U.S. Cl. CPC G01C 21/206; G06T 7/75; G06T 15/205; G06V 10/25; G06V 20/20; G09B 21/007

(57) ABSTRACT

The embodiments of the disclosure provide methods, apparatuses, electronic devices, and storage medium for assisted voice navigation. The following steps are cyclically performed in response to a first instruction indicating a first object within a first range: obtaining a first image, and determining a path based on the first image and a visual positioning model, wherein the visual positioning model represents a position distribution of an object within the first range in a three-dimensional simulation space, and the path is a movement path from a current position corresponding to the first image to a position where the first object is located; playing, based on the path, a navigation voice corresponding to the current position, the navigation voice representing a movement direction and a corresponding movement distance.

### CROSS-REFERENCE

This application claims priority to Chinese Patent Application No. 202211415769.0, filed on Nov. 11, 2022, and entitled “METHOD, APPARATUS, ELECTRONIC DEVICE AND STORAGE MEDIUM FOR ASSISTED VOICE NAVIGATION”, the entirety of which is incorporated herein by reference.

### FIELD

The embodiment of the disclosure relates to the technical field of intelligent terminals, in particular to a method, an apparatus, an electronic device and a storage medium for assisted voice navigation.

### BACKGROUND

At present, there are a huge number of visual impairment persons in our country. Since there are different degrees of visual impairment, the independent travel of the visual impairment person is greatly inconvenient. In the related technology of travel problem for the visual impairment person, a handheld intelligent terminal device is used to acquire image of the surrounding environment to realize environment perception, and convert the environment perception result into voice for broadcast, so that the user of the visual impairment can determine the surrounding environment based on the content of the voice broadcast.

However, the existing technology solutions have the problem of limited perception range and inability to achieve long-distance target navigation.

### SUMMARY

The embodiments of the disclosure provide a method, an apparatus, an electronic device, and a storage medium for assisted voice navigation, and aim to overcome the problem that the perception range of intelligent terminal device is limited and long-distance target navigation cannot be realized.

According to a first aspect, an embodiment of the present disclosure provides a method for assisted voice navigation, comprising:
in response to a first instruction indicating a first object within a first range, cyclically performing following steps: obtaining a first image, and determining a path based on the first image and a visual positioning model, the visual positioning model representing a position distribution of a second object within the first range in a three-dimensional simulation space, and the path being a movement path from a current position corresponding to the first image to a position where the first object is located; playing, based on the path, a navigation voice corresponding to the current position, the navigation voice representing a movement direction and a corresponding movement distance.

According to a second aspect, an embodiment of the present disclosure provides an apparatus for assisted voice navigation, comprising:
an interaction module, configured to, in response to a first instruction indicating a first object within a first range, cyclically invoke following modules:
a processing module, configured to obtain a first image, and determine a path based on the first image and a visual positioning model, the visual positioning model representing a position distribution of a second object within the first range in a three-dimensional simulation space, and the path being a movement path from a current position corresponding to the first image to a position where the first object is located;
a playing module, configured to play, based on the path, a navigation voice corresponding to the current position, the navigation voice representing a movement direction and a corresponding movement distance.

According to a third aspect, an embodiment of the present disclosure provides an electronic device, comprising:
a processor; and a memory communicatively connected to the processor;
the memory storing computer executable instructions;
the processor executing the computer executable instructions stored in the memory to implement a method of assisted voice navigation according to the above first aspect and the various possible designs thereof.

According to a fourth aspect, an embodiment of the present disclosure provides a computer-readable storage medium, wherein the computer-readable storage medium stores computer-executable instructions that, when executed by a processor, implement a method of assisted voice navigation according to the above first aspect and the various possible designs thereof.

According to a fifth aspect, an embodiment of the present disclosure provides a computer program product, comprising a computer program that, when executed by a processor, implements a method of assisted voice navigation according to the above first aspect and the various possible designs thereof.

The embodiments of the disclosure provide a method, an apparatus, an electronic device, and a storage medium for assisted voice navigation. The following steps are cyclically performing in response to a first instruction indicating a first object within a first range: obtaining a first image, and determining a path based on the first image and a visual positioning model, wherein the visual positioning model represents a position distribution of a second object within the first range in a three-dimensional simulation space, and the path is a movement path from a current position corresponding to the first image to a position where the first object is located; playing, based on the path, a navigation voice corresponding to the current position, the navigation voice representing a movement direction and a corresponding movement distance. By acquiring the first image and combining the visual positioning model, the position distribution of the object within the first range in the three-dimensional simulation space may be represented by using the visual positioning model. The movement path from the current position to the position where the first object is located is determined, and is converted into the voice for playing. In such a way, the user can reach the position of the first object outside the image acquisition field of view according to the played voice prompt. The perception and navigation range of the terminal device is improved, and the beyond-visual-range and long-distance target navigation is realized.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below. It will be apparent that the drawings in the following description are some embodiments of the present disclosure, and those skilled in the art may also obtain other drawings according to these drawings without creative labor.

FIG. 1 is an application scenario diagram of a method of assisted voice navigation according to an embodiment of the present disclosure;

FIG. 2 is a first schematic flowchart of the method of assisted voice navigation according to an embodiment of the present disclosure;

FIG. 3 is a flowchart of a specific implementation process of step S102 in the embodiment shown in FIG. 2;

FIG. 4 is a schematic diagram of a process of generating a target path according to an embodiment of the present disclosure;

FIG. 5 is a second schematic flowchart of the method of assisted voice navigation according to an embodiment of the present disclosure;

FIG. 6 is a schematic diagram of a process of playing an orientation voice according to an embodiment of the present disclosure;

FIG. 7 is a third schematic flowchart of the method of assisted voice navigation according to an embodiment of the present disclosure;

FIG. 8 is a flowchart of a specific implementation process of step S302 in the embodiment shown in FIG. 7;

FIG. 9 is a flowchart of a specific implementation process of step S303 in the embodiment shown in FIG. 7;

FIG. 10 is a flowchart of a specific implementation process of step S3033 in the embodiment shown in FIG. 9;

FIG. 11 is a structural block diagram of an apparatus for assisted voice navigation according to an embodiment of the present disclosure;

FIG. 12 is a schematic structural diagram of an electronic device according to an embodiment of the present disclosure;

FIG. 13 is a schematic diagram of a hardware structure of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. Obviously, the described embodiments are parts of but not all embodiments of this disclosure. All other embodiments obtained by those skilled in the art based on the embodiments of the present disclosure without creative efforts shall fall within the scope of the present disclosure.

The following describes an application scenario of an embodiment of the present disclosure.

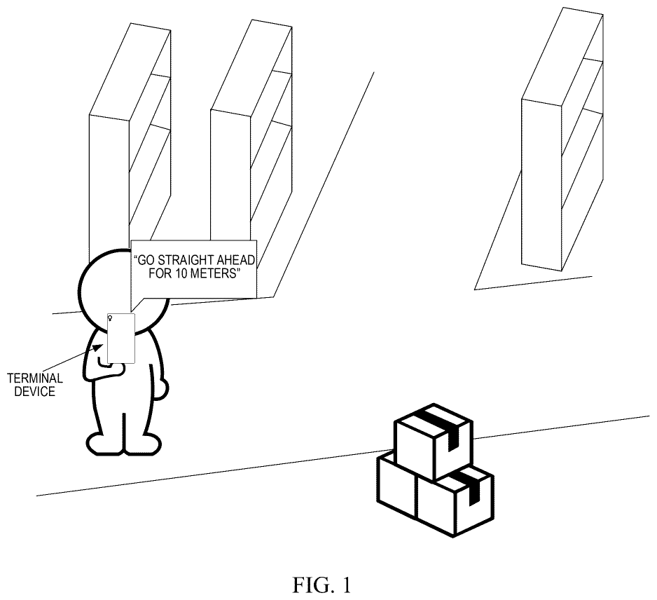

FIG. 1 is an application scenario diagram of a method of assisted voice navigation according to an embodiment of the present disclosure. The method of assisted voice navigation provided in this disclosed embodiment may be applied to travel scenarios with voice navigation for visual impaired users, more specifically, to application scenarios for indoor target object navigation for visual impaired users. As shown in FIG. 1, the method provided in the embodiments of the present disclosure may be applied to a terminal device, for example, a smart phone, a wearable device, or the like. As an example, the terminal device is in communication connection with the cloud service and performs data interaction with the cloud server. In an application scenario such as for indoor first object navigation for visual impaired users, after receiving the instruction for searching the target object by the visual barrier user, the terminal device acquires the environment image and converts the environment image into the corresponding navigation voice for broadcast. As shown in the figure, the content of the navigation voice is “go straight ahead for 10 meters”. The visual impaired user can walk according to the voice broadcast, and finally reach the position of the first object, thereby the first object navigation based on the assisted voice may be realized. More specifically, the application scenario for indoor first object navigation, for example, may be a scenario in which a specific book is found in a library, or a scenario in which a specific item is found in a supermarket.

In the related art, for the travel problem of the visual impaired person, a handheld intelligent terminal device is used to acquire image of the surrounding environment to realize environment perception, and convert the environment perception result into voice for broadcast, so that the user of the visual impairment can determine the surrounding environment based on the content of the voice broadcast. However, the above solution recognizes the environment image acquired in real time and converts it to generate the voice for broadcast, but the object outside the environment image cannot be perceived. Therefore, the voice generated by the above scheme can only provide general prompts, it cannot perceive and broadcast objects outside the environment image, nor can achieve navigation for objects outside the environment image.

The embodiment of the disclosure provides a method for assisted voice navigation to solve the problem.

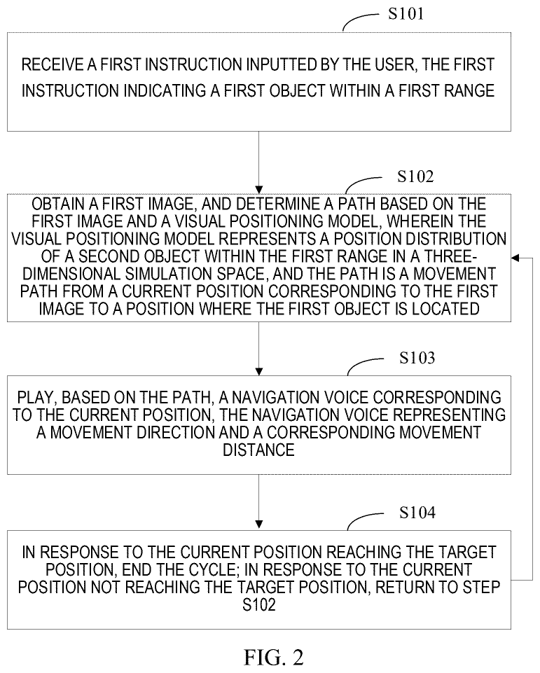

Referring to FIG. 2, which is a first schematic flowchart of the method for assisted voice navigation according to an embodiment of the present disclosure. The method of this embodiment may be applied to a terminal device, and the method for assisted voice navigation may comprise:
Step S101: receiving a first instruction inputted by the user, the first instruction indicating a first object within a first range.

For example, referring to the application scenario diagram shown in FIG. 1, the execution subject in this embodiment is a terminal device, for example, an intelligent wearable device. In a possible implementation, the first instruction is a voice instruction issued by a user. The terminal device detects voice signal at a predetermined frequency. When voice of a specific content is detected and recognized, a corresponding first instruction is obtained according to the voice content. More specifically, the terminal device may, for example, detect evocation speech through a low sampling rate. The content of evocation speech may be, for example, “Hello, little A”. After the evocation speech is detected, an instruction speech issued by the user may be detected at a high sampling rate, for example, “help me find the fruit shelf”. Then, the terminal device obtains a corresponding first instruction, that is, information indicating “fruit shelf”, by recognizing the instruction speech. In a further possible implementation, the first instruction is generated based on a gesture and a key-pressing operation of the user for the terminal device. For example, the terminal device is provided with a button Button_1, which may be a program button or a physical button. After the button Button_1 is triggered by the user, a corresponding first instruction is generated by the terminal device. The first instruction corresponds to a predetermined first object, for example, “room door”, that is, the first instruction is information representing “room door”.
Step S102: obtaining a first image, and determining a path based on the first image and a visual positioning model, wherein the visual positioning model represents a position distribution of a second object within the first range in a three-dimensional simulation space, and the path is a movement path from a current position corresponding to the first image to a position where the first object is located.

Further, after or while obtaining the first instruction, the terminal device obtains the image in the current environment, that is, the first image, by using the image acquisition unit provided thereon. For example, the first image may be a frame of image captured by the image acquisition unit, or may be a joined image and an overlapped image of a plurality of frames of images captured by the image acquisition unit. The joined image refers to an image with a larger image field of view formed by joining a plurality of frames of image based on the image field of view of the captured multi-frame pictures. The overlapped image refers to an image with higher contrast and definition obtained by overlapping the multiple frames of pictures with the same or similar image field of view. The specific implementations of joining and overlapping the plurality of frames of images to obtain the joined image and the overlapped image are not described herein again.

For example, after the first image is obtained, the first image is processed by using the visual positioning model, to obtain a movement path, that is, the target path, that represents the current position corresponding to the first image to the position where the first object is located. Specifically, the visual positioning model is a model that represents a position distribution of an object within the first range in a three-dimensional simulation space. For example, the three-dimensional simulation space is a simulation for a real environment in the first range, the visual positioning model is a model describing the three-dimensional simulation space. In short, the visual positioning model may be regarded as three-dimensional map data for the first range. More specifically, for example, the first range corresponds to an indoor range Zoom_1 of a supermarket. The three-dimensional simulation space is a virtual space that represents an environment and an object in the indoor range Zoom_1 of the supermarket, and the three-dimensional simulation space includes, for example, shelves, goods and roads in a supermarket. Further, the visual positioning model is a description of the three-dimensional simulation space, which for example comprises information such as an identifier, a volume, a position and the like of the goods and the road in the supermarket. There are a plurality of specific implementations of the visual positioning model, which may be implemented by using a three-dimensional pixel matrix and a corresponding article label, or may be implemented by describing information such as a label, a position, a volume and the like corresponding to each object via a configuration table. The specific implementation of the visual positioning model may be set as needed, which is not repeated herein.

Further, the visual positioning model may be a model deployed locally on the terminal device, or may be a model deployed in a cloud server in communication with the terminal device. In a possible implementation, the visual positioning model may be a visual positioning service (VPS) deployed in a cloud server that communicates with the terminal device.

After the visual positioning model is obtained, the visual positioning model is respectively searched with the first image and the first object to obtain the position corresponding to the first image and the position corresponding to the first object, and then the path is generated in combination with a predetermined navigation algorithm.

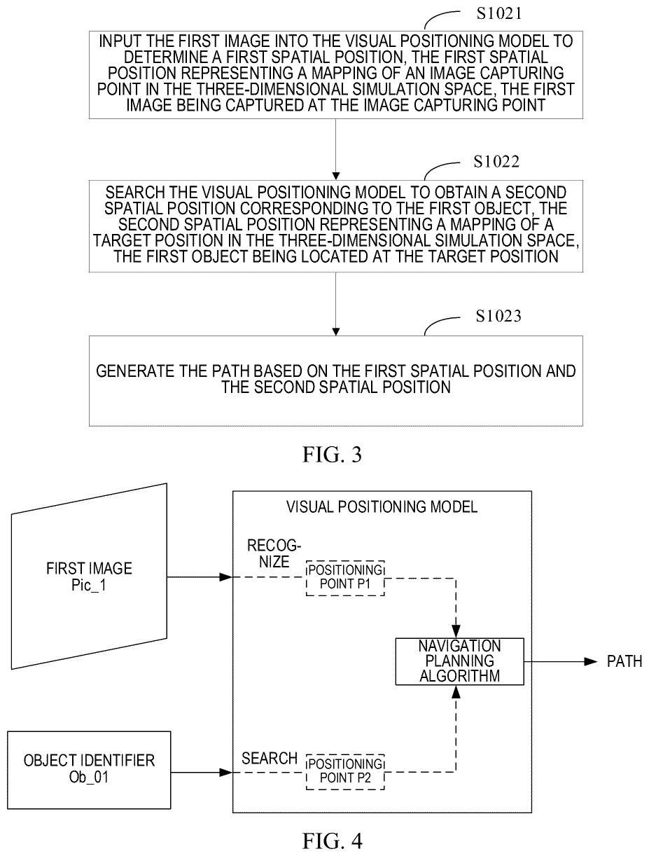

In a possible implementation, as shown in FIG. 3, the specific implementation of step S102 comprises:
Step S1021: inputting the first image into the visual positioning model to determine a first spatial position, the first spatial position representing a mapping of an image capturing point in the three-dimensional simulation space, the first image being captured at the image capturing point.
Step S1022: searching the visual positioning model to obtain a second spatial position corresponding to the first object, the second spatial position representing a mapping of a target position in the three-dimensional simulation space, the first object being located at the target position.
Step S1023: generating the path based on the first spatial position and the second spatial position.

For example, the first image is inputted into the visual positioning model for comparison search, to determine the position of the virtual environment region that is consistent with or similar to the region depicted by the first image in the three-dimensional simulation space, that is, the first spatial position, also known as the current position (of the terminal device). In short, the first spatial position is the mapping of the actual environment region depicted by the first image in the three-dimensional simulation space, and the first spatial position is expressed based on the visual positioning model, that is, expressed with the coordinate system in the three-dimensional simulation space represented by using the visual positioning model. After the first object is recognized based on the first instruction, an object identifier corresponding to the first object is obtained. For example, the first object recognized based on the first instruction is a “fruit shelf”, the corresponding object identifier is “#0021”. After that, a search is performed in the visual positioning model based on the object identifier to obtain a position coordinate of the first object “fruit shelf”, that is, the second spatial position. Similarly, the second spatial position is also expressed based on the visual positioning model, that is, expressed with the coordinate system in the three-dimensional simulation space represented by using the visual positioning model.

Then, the navigation path, that is, the target path, from the first spatial position to the second spatial position is implemented based on the road in the three-dimensional simulation space represented by the visual positioning model and the predetermined navigation planning algorithm. The algorithm for planning path based on the map data (visual positioning model) and the departure point (the first spatial position) and the target point (the second spatial position) is a well-known technology to those skilled in the art, and not repeated herein.

FIG. 4 is a schematic diagram of a process of generating a path according to an embodiment of the present disclosure. As shown in FIG. 4, the first image Pic_1 and the object identifier Ob_01 of the first object are inputted into the visual positioning model respectively. On one hand, the visual positioning model identifies based on the image content in the first image Pic_1, determines a mapping region of the image content in the three-dimensional simulation space, and further determines, based on the mapping region, the positioning point P1 of the image capturing point corresponding to the first image Pic_1 in the three-dimensional simulation space. On the other hand, the visual positioning model searches based on the object identifier Ob_01 to obtain the positioning point P2 corresponding to the object identifier Ob_01, and then inputs the positioning point P1 and the positioning point P2 into the navigation planning algorithm to generate the path, where the navigation planning algorithm may be the capability provided by the visual positioning model.
Step S103: playing, based on the path, a navigation voice corresponding to the current position, the navigation voice representing a movement direction and a corresponding movement distance.

After the path is obtained, according to the current position of the terminal device, that is, the first spatial position obtained in the previous steps, the corresponding movement direction and the movement distance along the path are determined. For example, the movement direction is “north”, and the movement distance is “10 m”. Based on a predetermined speech generating template, the information of the movement direction and the movement distance is converted into the corresponding navigation voice, for example, “move to north by 10 m”. In a possible implementation, in order for the visual impaired user to determine the movement direction, the terminal device may convert the absolute direction into the relative directions such as “left” and “right”. The specific conversion manner includes, for example, recognizing by using the first image and the visual positioning model, and determining the facing direction of the current user, so as to realize the conversion from the absolute direction to the relative direction. Then, the user is guided to move along the path from the current position by the broadcasted navigation voice, and finally reach the target position where the first object is located, thereby the first object navigation is achieved.
Step S104: in response to the current position reaching the target position, ending the cycle; in response to the current position not reaching the target position, returning to step S102.

For example, after the navigation voice is played, the latest current position may be obtained based on the current position obtained in the previous steps or by the additional position measurement. Whether the current position coincides with the target position is detected by using the visual positioning model. If the current position coincides with the target position, it indicates that the user (the terminal device) has reached the destination, and the navigation process is ended. If the two positions do not coincide, the procedure returns to the step S102 to re-obtain the real-time first image, and the above steps are repeated for voice navigation until the target position is reached.

In this embodiment, in response to a first instruction indicating a first object within a first range, the following steps are cyclically performed: obtaining a first image, and determining a path based on the first image and a visual positioning model, the visual positioning model representing a position distribution of an object within the first range in a three-dimensional simulation space, and the path being a movement path from a current position corresponding to the first image to a position where the first object is located; playing, based on the path, a navigation voice corresponding to the current position, the navigation voice representing a movement direction and a corresponding movement distance. By acquiring the first image and combining the visual positioning model, the position distribution of the object within the first range in the three-dimensional simulation space may be represented by using the visual positioning model. The movement path from the current position to the position where the first object is located is determined, and is converted into the voice for playing. In such a way, the user can reach the position of the first object outside the image acquisition field of view according to the played voice prompt. The perception and navigation range of the terminal device is improved, and the beyond-visual-range and long-distance target navigation is realized.

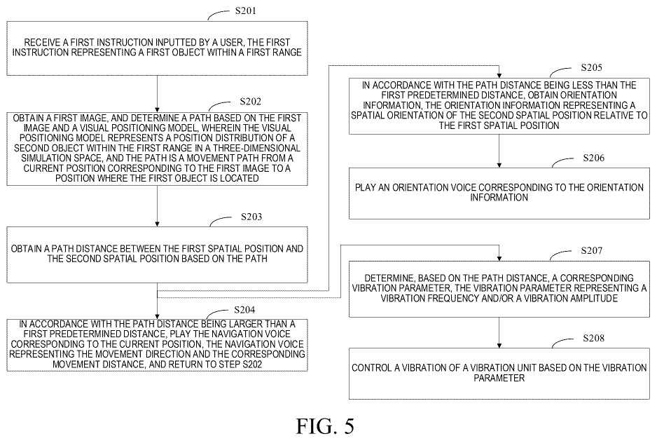

Referring to FIG. 5, which is a second schematic flowchart of a method of assisted voice navigation according to an embodiment of the present disclosure. On the basis of the embodiment shown in FIG. 2, this embodiment adds a step of performing orientation indication on the second spatial position, and the method of assisted voice navigation comprises:
Step S201: receiving a first instruction inputted by a user, wherein the first instruction represents a first object within a first range.
Step S202: obtaining a first image, and determining a path based on the first image and a visual positioning model, wherein the visual positioning model represents a position distribution of a second object within the first range in a three-dimensional simulation space, and the path is a movement path from a current position corresponding to the first image to a position where the first object is located.
Step S203: obtaining a path distance between the first spatial position and the second spatial position based on the path.
Step S204: in accordance with the path distance being larger than a first predetermined distance, playing the navigation voice corresponding to the current position, the navigation voice representing the movement direction and the corresponding movement distance, and returning to step S202.
Step S205: in accordance with the path distance being less than the first predetermined distance, obtaining orientation information, the orientation information representing a spatial orientation of the second spatial position relative to the first spatial position.
Step S206: playing an orientation voice corresponding to the orientation information.

For example, for the visual impaired user, in a scenario in which the first object is navigated in an indoor environment, even if the target user is guided to the target position through the navigation voice, there may still be a problem that the visual impaired user cannot locate the specific position of the first object. With respect to this problem, this embodiment further adds the step of playing the position voice when it is determined that the path distance is less than the first predetermined distance, thereby realizing accurate voice indication for the first object.

Specifically, for example, after the path is determined, the path distance between the first spatial position and the second spatial position is calculated, wherein the first spatial position represents the current position of the terminal device, the second spatial position represents the target position of the first object, and the path distance between the first spatial position and the second spatial position is the distance currently between the user (the terminal device) and the target position where the first object is located. The size of the virtual object and the distance between the virtual objects in the three-dimensional simulation space represented by the visual positioning model are set based on the size of the object in the first range within the real environment and the distance between the objects, for example, at a ratio of 1 to 1. Therefore, based on the path and the first spatial position and the second spatial position in the visual positioning model, a numerical value representing the path distance between the current position and the target position may be obtained. Then, it is determined, based on the path distance, that the user has approached the first object when the path distance is less than or equal to the first predetermined distance, for example, 1 m, it may be considered that the target position has been reached. At this time, it may be recognized with the first image or other reference information to obtain the spatial orientation representing the second spatial position (the target position) relative to the first spatial position (the current position). The orientation information may be an angle value with a direction identifier, for example, 30 degrees in front and 20 degrees in the left. Then, the orientation information is converted to generate the orientation voice for broadcast, so that the user can further determine the orientation relationship between the target position where the first object is located and the current position, to accurately position the first object.

On the other hand, if the path distance is greater than the first predetermined distance, it indicates that there is still a long distance from the first object at this time, and there is no need to determine the orientation of the first object. Therefore, the navigation voice corresponding to the current position is played, and the specific implementation process is described in the embodiment shown in FIG. 2, which is not repeated herein.

In addition, after step S203, the method further comprises:
Step S207: determining, based on the path distance, a corresponding vibration parameter, the vibration parameter representing a vibration frequency and/or a vibration amplitude;
Step S208: controlling a vibration of a vibration unit based on the vibration parameter.

For example, the terminal device is provided with a vibration unit for generating vibration by the user. The vibration frequency and/or the vibration amplitude of the vibration emitted by the vibration unit is related to the path distance. In a possible implementation, after the real-time path distance is determined, a corresponding vibration parameter is set based on the path distance. The smaller the path distance, the greater the vibration amplitude and/or the vibration amplitude. Alternatively, when the path distance is less than the first predetermined distance, the vibration unit is started, or the vibration frequency and/or the vibration amplitude is increased.

When the orientation of the first object is broadcasted based on the orientation voice, the visual impaired user may still be moving during playing the orientation voice (that is, when reaching the target position) due to the poor real-time performance of the voice broadcast, resulting in the situation of “passing by”. Therefore, the current actual position of the user does not match the current position corresponding to the orientation information indicated by the orientation voice, and then the visual impaired user cannot get the first object according to the orientation indicated by the orientation voice. In this embodiment, with the good real-time performance and continuously changing characteristics of vibration prompts, the visual impaired user can determine whether or not to reach the target position based on the vibration generated by the vibration unit with continuously changing vibration characteristic (vibration frequency and/or vibration amplitude). By utilizing the real-time and continuously changing characteristics of vibration prompts, visually impaired users can predict whether they will reach the target position based on the continuously changing vibration characteristics (vibration frequency and/or amplitude) generated by the vibration unit. When the target position is reached (when the path distance is less than the first predetermined distance), the vibration characteristics of the vibration unit are controlled to change, allowing the user to receive targeted instructions in time and stop moving, and then realizing the accurate taking of the first object in combination with the orientation voice.

The following describes a specific embodiment.

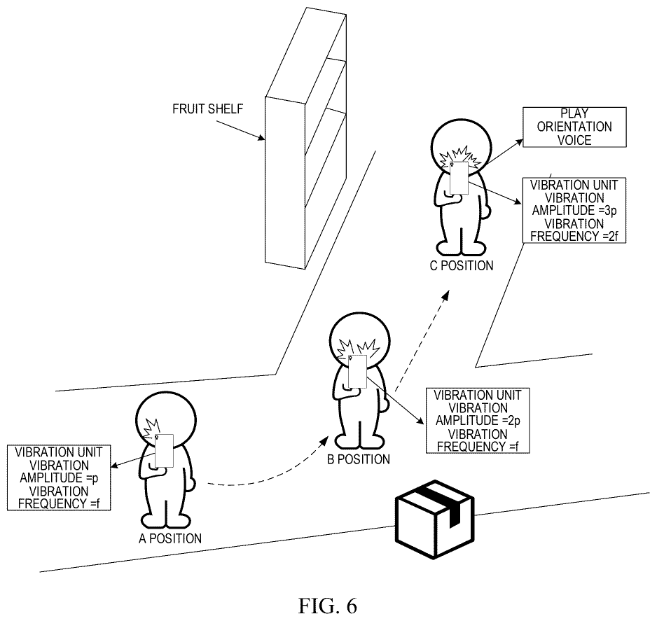

FIG. 6 is a schematic diagram of a process of playing an orientation voice according to an embodiment of the present disclosure. As shown in FIG. 6, for example, the terminal device is a smart phone, and corresponds to an application scenario of indoor navigation in a supermarket, specifically, the first object is, for example, a “fruit shelf”. In a process of a user moving based on a navigation voice to a target position corresponding to the first object, the terminal device obtains a first image in real time, determines a first spatial position, calculates a path distance between the first spatial position and a second spatial position corresponding to the target position, adjusts a vibration amplitude of the vibration unit based on the path distance, the shorter the path distance, and the larger the vibration amplitude. For example, as shown in the figure, when the user (the terminal device) is located at the position A of the path, the vibration amplitude of the vibration emitted by the vibration unit is p millimeters/second (mm/s). When the user (the terminal device) is located at a position B closer to the target position, the vibration amplitude of the vibration emitted by the vibration unit is 2p mm/s. The amplitude of the vibration emitted by the vibration unit in the process continuously changes, but the vibration frequencies of the vibration units corresponding to the position A and the position B are consistent, both are f Hertz (Hz). When the user (the terminal device) reaches the position C corresponding to the target position (the path distance is less than the first predetermined distance), the vibration amplitude of the vibration emitted by the vibration unit is 3p mm/s, the vibration frequency is changed to 2f Hz. At this time, the vibration frequency is changed suddenly, thereby prompting the user that the target position is reached and may stop moving. Then, the terminal device generates and plays the orientation voice based on the orientation information calculated from the first image of the same frame, to indicate the orientation of the first object, so that the user can accurately get the first object based on the guidance of the orientation voice.

In this embodiment, steps S201-S202 are consistent with steps S101-S102 in the embodiment shown in FIG. 2. For detailed discussion, please refer to the discussion of steps S101-S102, which is not repeated here.

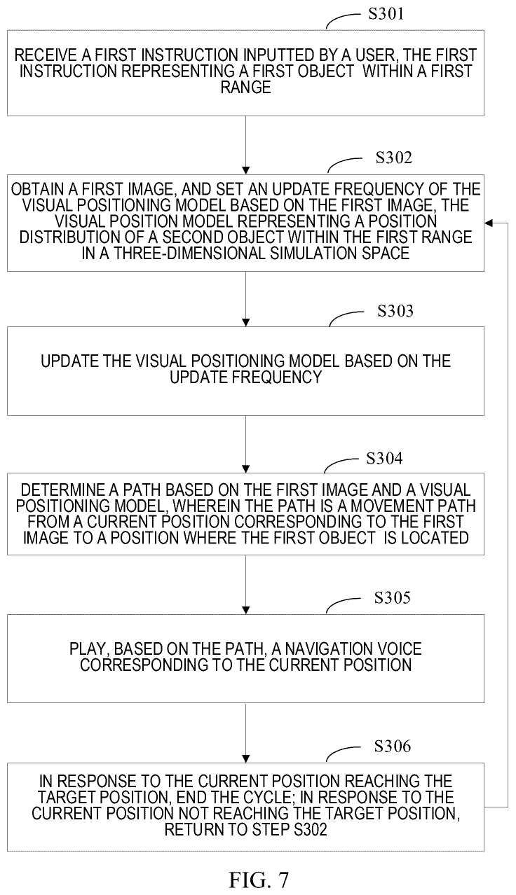

Referring to FIG. 7, which is a third schematic flowchart of the method of assisted voice navigation according to an embodiment of the present disclosure. On the basis of the embodiment shown in FIG. 2, this embodiment adds a step of updating the visual positioning model, and the method of assisted voice navigation comprises:
Step S301: receiving a first instruction inputted by a user, wherein the first instruction represents a first object within a first range.
Step S302: obtaining a first image, and setting an update frequency of the visual positioning model based on the first image, the visual position model representing a position distribution of an object within the first range in a three-dimensional simulation space.

For example, the visual positioning model is a model that represents the position distribution of the object within the first range in the three-dimensional simulation space. In some specific application scenarios, when the object within the first range changes, the visual positioning model needs to be updated synchronously to ensure the accuracy of the visual positioning model, thereby ensuring the accuracy of the path generated based on the visual positioning model, and avoiding the problem that the visual positioning model does not update in time, resulting in the generated path causing the visual impaired user to collide. Then, since the number of first objects involved in the visual positioning model is large and the amount of data is large, especially when the first range is large, the frequent update of visual positioning model may cause unnecessary overheads and resource waste. In a possible implementation, the update frequency of the corresponding visual positioning model is determined by detecting the change of the first image. When the change of the first image is large, it indicates that the object in the current environment, that is, within the first range, changes more frequently. At this time, a higher update frequency is set for the visual positioning model, and the accuracy of the visual positioning model is improved. Otherwise, a lower update frequency is set for the visual positioning model, thereby reducing consumption of various resources.

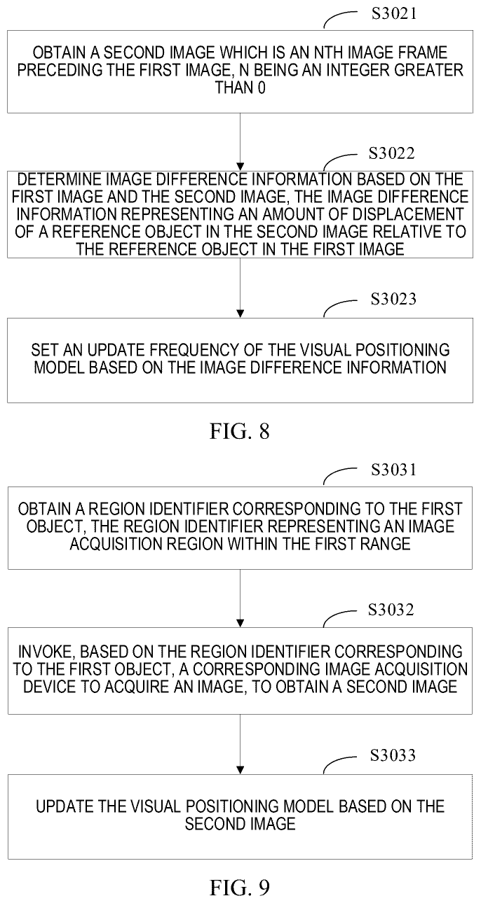

In a possible implementation, as shown in FIG. 8, the specific implementation of step S302 comprises:
Step S3021: obtaining a second image which is an Nth image frame preceding the first image, N being an integer greater than 0.
Step S3022: determining image difference information based on the first image and the second image, the image difference information representing an amount of displacement of a reference object in the second image relative to the reference object in the first image.
Step S3023: setting an update frequency of the visual positioning model based on the image difference information.

For example, in the process of acquiring the first image cyclically, the first image acquired in the last N times is saved as a historical environment picture. Then, after each acquisition of the first image, the Nth image frame preceding the first image is extracted, that is, as the second image, N is an integer greater than 0, for example, 30, the first image currently acquired in real time is compared with the first image (the second image) acquired before the 30 frames, to obtain the image difference information representing the amount of displacement of the reference object in the second image relative to the reference object in the first image. The reference object in the second image and the reference object in the first image are the same object, such as a pedestrian, a vehicle, and the like. When the amount of displacement of the reference object in the second image and the reference object in the first image is large, it indicates that the object in the current environment changes relatively frequently, and a higher update frequency is correspondingly set; otherwise, when the amount of displacement of the reference object in the second image and the reference object in the first image is small, it indicates that the object in the current environment changes infrequently, then a lower frequency is correspondingly set, thereby improving the utilization of computing resources and network resources.
Step S303: updating the visual positioning model based on the update frequency.

For example, after the update frequency is obtained, the visual positioning model is updated based on the update frequency, for example, every 30 frames or every one minute. In a possible implementation, the visual positioning model corresponds to a plurality of spatial regions. After the update frequency is obtained, data corresponding to all spatial regions in the visual positioning model may be updated based on the update frequency, or only data corresponding to the spatial region corresponding to the current position (the first spatial position) may be updated, thereby improving resource utilization.

In another possible implementation, as shown in FIG. 9, the specific implementation of step S303 comprises:
Step S3031: obtaining a region identifier corresponding to the first object, the region identifier representing an image acquisition region within the first range;
Step S3032: invoking, based on the region identifier corresponding to the first object, a corresponding image acquisition device to acquire an image, to obtain a second image;
Step S3033: updating the visual positioning model based on the second image.

For example, in another implementation, the terminal device is in direct or indirect communication connection with the image acquisition device. The image acquisition device is, for example, a distributed intelligent camera based on Internet of Things, and the image acquisition device communicates with the terminal device, or communicates with the cloud server, receives an image acquisition instruction sent from the terminal device or the cloud server, and performs image acquisition. The distributed intelligent cameras respectively correspond to one image acquisition region, and model updating is performed on the visual positioning model by acquiring images of the image acquisition region. In a possible application scenario, the first object is an object with a movement capability, such as a service robot in a library or a supermarket. Therefore, the position of the first object changes randomly. For this application scenario, in the embodiment, after determining the first object, the terminal device determines an image acquisition region corresponding to the first object by querying the visual positioning model, obtains an region identifier corresponding to the first object, and then invokes the image acquisition device corresponding to the region identifier, acquires a second image based on the update frequency determined in the previous step, and updates the visual positioning model based on the second image. Thus, the position information of the first object stored in the visual positioning model is more accurate and real-time.

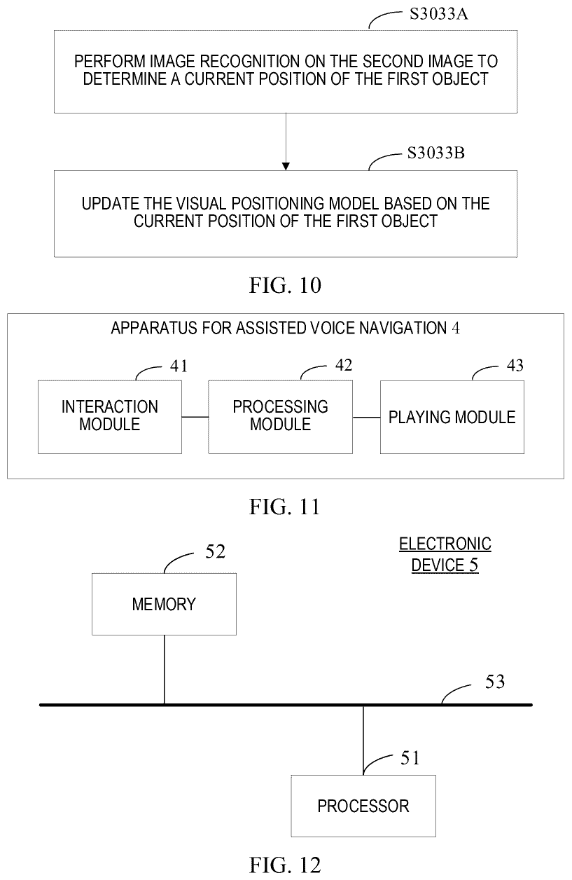

For example, as shown in FIG. 10, the specific implementation of step S3033 includes:
Step S3033A: performing image recognition on the second image to determine a current position of the first object.
Step S3033B: updating the visual positioning model based on the current position of the first object.

In this embodiment, the region identifier corresponding to the first object is obtained, and the corresponding distributed image acquisition device is invoked to perform region image acquisition based on the region identifier, thus the targeted updating of the dynamic first object is realized. In such a way, it is ensured that the generated path is accurate and reasonable, avoiding the problem of resource waste caused by excessively updating the visual positioning model.
Step S304: determining a path based on the first image and a visual positioning model, wherein the path is a movement path from a current position corresponding to the first image to a position where the first object is located.
Step S305: playing, based on the path, a navigation voice corresponding to the current position.
Step S306: in response to the current position reaching the target position, ending the cycle; in response to the current position not reaching the target position, returning to step S302.

In this embodiment, the specific implementation of steps S301, S304 and S305 are consistent with steps S101-S103 in the embodiment shown in FIG. 2. For the details, please refer to the discussion of steps S101-S103 in the embodiment shown in FIG. 2, which is not repeated herein.

It should be noted that, the method of assisted voice navigation provided in this embodiment may also be implemented on the basis of the embodiment shown in FIG. 5. That is, based on this embodiment, the technical features of setting the vibration unit based on the path distance in the embodiment shown in FIG. 5 (steps S203 to S208) are further combined, so as to achieve the purpose of controlling the vibration unit and playing the orientation voice, and details thereof are not repeated herein.

Corresponding to the method of assisted voice navigation in the above embodiment, FIG. 11 is a structural block diagram of an apparatus for assisted voice navigation according to an embodiment of the present disclosure. For ease of illustration, only portions related to embodiments of the present disclosure are shown. Referring to FIG. 11, the apparatus for assisted voice navigation 4 comprises:
an interaction module, configured to, in response to a first instruction indicating a first object within a first range, cyclically invoke following modules:
a processing module 42, configured to obtain a first image, and determine a path based on the first image and a visual positioning model, the visual positioning model representing a position distribution of a second object within the first range in a three-dimensional simulation space, and the path being a movement path from a current position corresponding to the first image to a position where the first object is located;
a playing module 43, configured to play, based on the path, a navigation voice corresponding to the current position, the navigation voice representing a movement direction and a corresponding movement distance.

In an embodiment of the present disclosure, when determining the path based on the first image and the visual positioning model, the processing module 42 is specifically configured to: input the first image into the visual positioning model to determine a first spatial position, the first spatial position representing a mapping of an image capturing point in the three-dimensional simulation space, the first image being captured at the image capturing point; obtain, based on the visual positioning model, a second spatial position corresponding to the first object, the second spatial position representing a mapping of a target position in the three-dimensional simulation space, the first object being located at the target position; generate the path based on the first spatial position and the second spatial position.

In an embodiment of the present disclosure, the processing module 42 is further configured to: obtain a path distance between the first spatial position and the second spatial position based on the path; in accordance with the path distance being less than a first predetermined distance, obtain orientation information, the orientation information representing a spatial orientation of the second spatial position relative to the first spatial position; the playing module 43 is further configured to play an orientation voice corresponding to the orientation information.

In an embodiment of the present disclosure, the processing module 42 is further configured to: determine, based on the path distance, a corresponding vibration parameter, the vibration parameter representing a vibration frequency and/or a vibration amplitude; control a vibration of a vibration unit based on the vibration parameter.

In an embodiment of the present disclosure, the processing module 42 is further configured to: obtain a second image which is an Nth image frame preceding the first image, N being an integer greater than 0; determine image difference information based on the first image and the second image, the image difference information representing an amount of displacement of a reference object in the second image relative to the reference object in the first image; set an update frequency of the visual positioning model based on the image difference information; update the visual positioning model based on the update frequency.

In an embodiment of the present disclosure, the processing module 42 is further configured to: obtain a region identifier corresponding to the first object, the region identifier representing an image acquisition region in the first range; invoke, based on the region identifier corresponding to the first object, a corresponding image acquisition device to acquire an image, to obtain a second image; update the visual positioning model based on the second image.

In an embodiment of the present disclosure, when updating the visual positioning model based on the second image, the processing module 42 is further configured to: perform image recognition on the second image to determine a current position of the first object; update the visual positioning model based on the current position of the first object.

The interaction module 41, the processing module 42, and the playing module 43 are connected in sequence. The apparatus for assisted voice navigation 4 provided in this embodiment may perform the technical solutions of the foregoing method embodiments, and implementation principles and technical effects thereof are similar, and details are not repeated in this embodiment.

FIG. 12 is a schematic structural diagram of an electronic device according to an embodiment of the present disclosure. As shown in FIG. 12, the electronic device 5 comprises:
a processor 51; and a memory 52 communicatively connected to the processor 51;
the memory 52 storing computer executable instructions;
the processor 51 executing the computer executable instructions stored in the memory 52 to implement a method of assisted voice navigation in the embodiments shown in FIG. 2 to FIG. 10.

Optionally, the processor 51 and the memory 52 are connected by a bus 53.

Related descriptions may be understood with reference to related descriptions and effects corresponding to the steps in the embodiments corresponding to FIG. 2 to FIG. 10, and details are not described herein again.

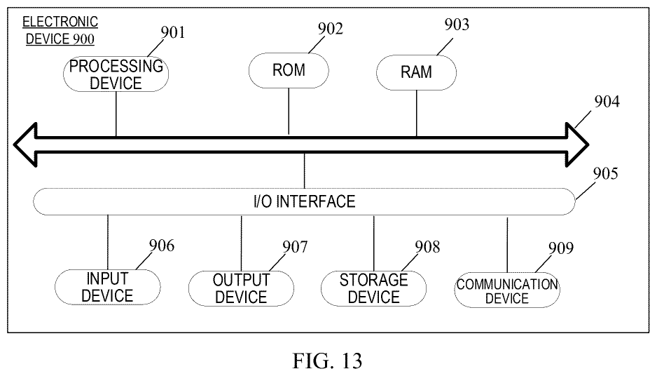

Referring to FIG. 13, which shows a schematic structural diagram of an electronic device 900 suitable for implementing embodiments of the present disclosure, and the electronic device 900 may be a terminal device or a server. The terminal device may include, but is not limited to, a mobile terminal such as a mobile phone, a notebook computer, a digital broadcast receiver, a personal digital assistant (PDA), a portable Android device (PAD), a portable media player (PMP), an on-board terminal (for example, an n-board navigation terminal), and a fixed terminal such as a digital TV, a desktop computer, or the like. The electronic device shown in FIG. 13 is merely an example, and should not impose any limitation on the functions and use scope of the embodiments of the present disclosure.

As shown in FIG. 13, the electronic device 900 may comprise a processing device (for example, a central processor, a graphics processor, etc.) 901, which may perform various appropriate actions and processes according to a program stored in a read only memory (ROM) 902 or a programs loaded into a random access memory (RAM) 903 from a storage device 908. In the RAM 903, various programs and data required by the operation of the electronic device 900 are also stored. The processing device 901, the ROM 902, and the RAM 903 are connected to each other via a bus 904. The input/output (I/O) interface 905 is also connected to bus 904.

Generally, the following devices may be connected to the I/O interface 905: an input device 906 including, for example, a touch screen, a touch pad, a keyboard, a mouse, a camera, a microphone, an accelerometer, a gyroscope, etc.; an output device 907 including, for example, a liquid crystal display (LCD), a speaker, a vibrator, etc.; a storage device 908 including, for example, a magnetic tape, a hard disk, etc.; and a communication device 909. The communication device 909 may allow the electronic device 900 to communicate wirelessly or wired with other devices to exchange data. While FIG. 13 shows an electronic device 900 with various devices, it should be understood that it is not required to implement or have all illustrated devices. Alternatively, more or less devices may be implemented or provided.

In particular, according to an embodiment of the present disclosure, the process described above with reference to the flowchart may be implemented as a computer software program. For example, embodiments of the present disclosure comprise a computer program product that comprises a computer program embodied on a computer readable medium, the computer program comprising program codes for performing the method shown in the flowchart. In such embodiments, the computer program may be downloaded and installed from the network via the communication device 909, or installed from the storage device 908, or installed from the ROM 902. The computer program, when executed by the processing apparatus 901, performs the foregoing functions defined in the method of the embodiments of the present disclosure.

It should be noted that the computer-readable medium described above may be a computer readable signal medium, a computer readable storage medium, or any combination thereof. The computer-readable storage medium may be, for example, but not limited to, an electronic, magnetic, optical, electromagnetic, infrared, or semiconductor system, apparatus, or device, or any combination thereof. More specific examples of computer-readable storage media may include, but are not limited to, the following: an electrical connection with one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium including or storing a program that may be used by or in conjunction with an instruction execution system, apparatus, or device. In the present disclosure, the computer readable signal medium may include a data signal propagated in baseband or as part of a carrier, in which computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in conjunction with an instruction execution system, apparatus, or device. The program code embodied on the computer-readable medium may be transmitted by any suitable medium, including, but not limited to: wires, optical cables, RF (radio frequency), and the like, or any suitable combination of the foregoing.

The computer-readable medium described above may be included in the electronic device; or may be separately present without being assembled into the electronic device.

The computer-readable medium carries one or more programs which, when executed by the electronic device, cause the electronic device to perform the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user's computer, partially on a user's computer, as a stand-alone software package, partially on a user's computer and partially on a remote computer, or entirely on a remote computer or server. In the latter scenario, the remote computer may be connected to the user's computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowcharts or block diagrams may represent a module, program segment, or portion of code that includes one or more executable instructions for implementing the specified logical function(s). It should also be noted that in some alternative implementations, the functions noted in the blocks may also occur in a different order than that illustrated in the figures. For example, two blocks shown consecutively may actually be executed concurrently, or the blocks may sometimes be executed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software or may be implemented in hardware. The name of a unit in some situation does not form any limitation on the unit itself. For example, the first obtaining unit may be further described as “a unit for obtaining at least two Internet Protocol addresses”.

The functions described above may be performed, at least in part, by one or more hardware logic components. For example, without limitation, example types of hardware logic components that may be used include: field programmable gate arrays (FPGAs), application specific integrated circuits (ASICs), application specific standard products (ASSPs), system-on-chips (SOCs), complex programmable logic devices (CPLDs), and the like.

In the context of the present disclosure, the machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

In a first aspect, a method of assisted voice navigation is provided according to one or more embodiments of the present disclosure, comprising:
in response to a first instruction indicating a first object within a first range, cyclically performing following steps: obtaining a first image, and determining a path based on the first image and a visual positioning model, the visual positioning model representing a position distribution of an object within the first range in a three-dimensional simulation space, and the path being a movement path from a current position corresponding to the first image to a position where the first object is located; playing, based on the path, a navigation voice corresponding to the current position, the navigation voice representing a movement direction and a corresponding movement distance.

According to one or more embodiments of the disclosure, determining the path based on the first image and the visual positioning model comprises: inputting the first image into the visual positioning model to determine a first spatial position, the first spatial position representing a mapping of an image capturing point in the three-dimensional simulation space, the first image being captured at the image capturing point; obtaining, based on the visual positioning model, a second spatial position corresponding to the first object, the second spatial position representing a mapping of a target position in the three-dimensional simulation space, the first object being located at the target position; generating the path based on the first spatial position and the second spatial position.

According to one or more embodiments of the disclosure, the method further comprises: obtaining a path distance between the first spatial position and the second spatial position based on the path; in accordance with the path distance being less than a first predetermined distance, obtaining orientation information, the orientation information representing a spatial orientation of the second spatial position relative to the first spatial position; playing an orientation voice corresponding to the orientation information.

According to one or more embodiments of the disclosure, the method further comprises: determining, based on the path distance, a corresponding vibration parameter, the vibration parameter representing a vibration frequency and/or a vibration amplitude; controlling a vibration of a vibration unit based on the vibration parameter.

According to one or more embodiments of the disclosure, the method further comprises: obtaining a second image which is an Nth image frame preceding the first image, N being an integer greater than 0; determining image difference information based on the first image and the second image, the image difference information representing an amount of displacement of a reference object in the second image relative to the reference object in the first image; setting an update frequency of the visual positioning model based on the image difference information; updating the visual positioning model based on the update frequency.

According to one or more embodiments of the disclosure, the method further comprises: obtaining a region identifier corresponding to the first object, the region identifier representing an image acquisition region in the first range; invoking, based on the region identifier corresponding to the first object, a corresponding image acquisition device to acquire an image, to obtain a second image; updating the visual positioning model based on the second image.

According to one or more embodiments of the disclosure, updating the visual positioning model based on the second image comprises: performing image recognition on the second image to determine a current position of the first object; updating the visual positioning model based on the current position of the first object.

In a second aspect, an apparatus for assisted voice navigation is provided according to one or more embodiments of the present disclosure, comprising:
an interaction module, configured to, in response to a first instruction indicating a first object within a first range, cyclically invoke following modules:
a processing module, configured to obtain a first image, and determine a path based on the first image and a visual positioning model, the visual positioning model representing a position distribution of an object within the first range in a three-dimensional simulation space, and the path being a movement path from a current position corresponding to the first image to a position where the first object is located;
a playing module, configured to play, based on the path, a navigation voice corresponding to the current position, the navigation voice representing a movement direction and a corresponding movement distance.

According to one or more embodiments of the disclosure, when determining the path based on the first image and the visual positioning model, the processing module is specifically configured to: input the first image into the visual positioning model to determine a first spatial position, the first spatial position representing a mapping of an image capturing point in the three-dimensional simulation space, the first image being captured at the image capturing point; obtain, based on the visual positioning model, a second spatial position corresponding to the first object, the second spatial position representing a mapping of a target position in the three-dimensional simulation space, the first object being located at the target position; generate the path based on the first spatial position and the second spatial position.

According to one or more embodiments of the disclosure, the processing module is further configured to: obtain a path distance between the first spatial position and the second spatial position based on the path; in accordance with the path distance being less than a first predetermined distance, obtain orientation information, the orientation information representing a spatial orientation of the second spatial position relative to the first spatial position; the playing module is further configured to play an orientation voice corresponding to the orientation information.

According to one or more embodiments of the disclosure, the processing module is further configured to: determine, based on the path distance, a corresponding vibration parameter, the vibration parameter representing a vibration frequency and/or a vibration amplitude; control a vibration of a vibration unit based on the vibration parameter.

According to one or more embodiments of the disclosure, the processing module is further configured to: obtain a second image which is an Nth image frame preceding the first image, N being an integer greater than 0; determine image difference information based on the first image and the second image, the image difference information representing an amount of displacement of a reference object in the second image relative to the reference object in the first image; set an update frequency of the visual positioning model based on the image difference information; update the visual positioning model based on the update frequency.

According to one or more embodiments of the disclosure, the processing module is further configured to: obtain a region identifier corresponding to the first object, the region identifier representing an image acquisition region in the first range; invoke, based on the region identifier corresponding to the first object, a corresponding image acquisition device to acquire an image, to obtain a second image; update the visual positioning model based on the second image.

According to one or more embodiments of the disclosure, when updating the visual positioning model based on the second image, the processing module is further configured to: perform image recognition on the second image to determine a current position of the first object; update the visual positioning model based on the current position of the first object.

In a third aspect, an electronic device is provided according to one or more embodiments of the disclosure, comprising: a processor; and a memory communicatively connected to the processor;
the memory storing computer executable instructions;
the processor executing the computer executable instructions stored in the memory to implement a method of assisted voice navigation according to the first aspect and various possible designs thereof.

In a fourth aspect, a computer-readable storage medium is provided according to one or more embodiments of the disclosure, wherein the computer-readable storage medium stores computer-executable instructions that, when executed by a processor, implement a method of assisted voice navigation according to the first aspect and various possible designs thereof.

In a fifth aspect, a computer program product is provided according to one or more embodiments of this disclosure, comprising a computer program that, when executed by a processor, implements a method of assisted voice navigation according to the first aspect and various possible designs thereof.

The above description is merely an illustration of the preferred embodiments of the present disclosure and the principles of the applied technology. It should be understood by those skilled in the art that the disclosure in the present disclosure is not limited to the technical solutions of the specific combination of the above technical features, but should also cover other technical solutions formed by any combination of the above technical features or their equivalent features without departing from the above disclosed concept, e.g., technical solutions formed by replacing the above features with technical features having similar functions disclosed (without limitation) in the present disclosure.

Further, while operations are depicted in a particular order, it should not be construed as requiring that these operations be performed in the particular order shown or in sequential order. In certain circumstances, multitasking and parallel processing may be advantageous. Likewise, although several specific implementation details are included in the discussion above, these should not be construed as limiting the scope of the present disclosure. Some features described in the context of separate embodiments may also be realized in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is should be understood that the subject matter defined in the appended claims is not necessarily limited to the specific features or acts described above. Rather, the specific features and acts described above are merely exemplary forms of implementing the claims.

1. A method of assisted voice navigation, comprising:
in response to a first instruction indicating a first object within a first range, cyclically performing following steps:
obtaining a first image, and determining a path based on the first image and a visual positioning model, the visual positioning model representing a position distribution of a second object within the first range in a three-dimensional simulation space, and the path being a movement path from a current position corresponding to the first image to a position where the first object is located; and
playing, based on the path, a navigation voice corresponding to the current position, the navigation voice representing a movement direction and a corresponding movement distance.

2. The method of claim 1, wherein determining the path based on the first image and the visual positioning model comprises:
inputting the first image into the visual positioning model to determine a first spatial position, the first spatial position representing a mapping of an image capturing point in the three-dimensional simulation space, the first image being captured at the image capturing point;
obtaining, based on the visual positioning model, a second spatial position corresponding to the first object, the second spatial position representing a mapping of a target position in the three-dimensional simulation space, the first object being located at the target position; and
generating the path based on the first spatial position and the second spatial position.

3. The method of claim 2, further comprising:
obtaining a path distance between the first spatial position and the second spatial position based on the path;
in accordance with the path distance being less than a first predetermined distance, obtaining orientation information, the orientation information representing a spatial orientation of the second spatial position relative to the first spatial position; and
playing an orientation voice corresponding to the orientation information.

4. The method of claim 3, further comprising:
determining, based on the path distance, a corresponding vibration parameter, the vibration parameter representing a vibration frequency and/or a vibration amplitude; and
controlling a vibration of a vibration unit based on the vibration parameter.

5. The method of claim 2, further comprising:
obtaining a second image which is an Nth image frame preceding the first image, N being an integer greater than 0;
determining image difference information based on the first image and the second image, the image difference information representing an amount of displacement of a reference object in the second image relative to the reference object in the first image;
setting an update frequency of the visual positioning model based on the image difference information; and
updating the visual positioning model based on the update frequency.

6. The method of claim 1, further comprising:
obtaining a region identifier corresponding to the first object, the region identifier representing an image acquisition region within the first range;
invoking, based on the region identifier corresponding to the first object, a corresponding image acquisition device to acquire an image, to obtain a second image; and
updating the visual positioning model based on the second image.

7. The method of claim 6, wherein updating the visual positioning model based on the second image comprises:
performing image recognition on the second image to determine a current position of the first object; and
updating the visual positioning model based on the current position of the first object.

8. (canceled)

9. An electronic device, comprising: a processor; and
a memory communicatively connected to the processor;
the memory storing computer executable instructions; and
the processor executing the computer executable instructions stored in the memory to implement acts comprising:
in response to a first instruction indicating a first object within a first range, cyclically performing following steps:
obtaining a first image, and determining a path based on the first image and a visual positioning model, the visual positioning model representing a position distribution of a second object within the first range in a three-dimensional simulation space, and the path being a movement path from a current position corresponding to the first image to a position where the first object is located; and
playing, based on the path, a navigation voice corresponding to the current position, the navigation voice representing a movement direction and a corresponding movement distance.

10. A non-transitory computer-readable storage medium, wherein the computer-readable storage medium stores computer-executable instructions that, when executed by a processor, implement a method comprising:
in response to a first instruction indicating a first object within a first range, cyclically performing following steps:
obtaining a first image, and determining a path based on the first image and a visual positioning model, the visual positioning model representing a position distribution of a second object within the first range in a three-dimensional simulation space, and the path being a movement path from a current position corresponding to the first image to a position where the first object is located; and
playing, based on the path, a navigation voice corresponding to the current position, the navigation voice representing a movement direction and a corresponding movement distance.

11. (canceled)

12. The electronic device of claim 9, wherein determining the path based on the first image and the visual positioning model comprises:
inputting the first image into the visual positioning model to determine a first spatial position, the first spatial position representing a mapping of an image capturing point in the three-dimensional simulation space, the first image being captured at the image capturing point;
obtaining, based on the visual positioning model, a second spatial position corresponding to the first object, the second spatial position representing a mapping of a target position in the three-dimensional simulation space, the first object being located at the target position; and
generating the path based on the first spatial position and the second spatial position.

13. The electronic device of claim 12, the acts further comprise:
obtaining a path distance between the first spatial position and the second spatial position based on the path;
in accordance with the path distance being less than a first predetermined distance, obtaining orientation information, the orientation information representing a spatial orientation of the second spatial position relative to the first spatial position; and
playing an orientation voice corresponding to the orientation information.

14. The electronic device of claim 13, the acts further comprise:
determining, based on the path distance, a corresponding vibration parameter, the vibration parameter representing a vibration frequency and/or a vibration amplitude; and
controlling a vibration of a vibration unit based on the vibration parameter.

15. The electronic device of claim 12, the acts further comprise:
obtaining a second image which is an Nth image frame preceding the first image, N being an integer greater than 0;
determining image difference information based on the first image and the second image, the image difference information representing an amount of displacement of a reference object in the second image relative to the reference object in the first image;
setting an update frequency of the visual positioning model based on the image difference information; and
updating the visual positioning model based on the update frequency.

16. The electronic device of claim 9, the acts further comprise:
obtaining a region identifier corresponding to the first object, the region identifier representing an image acquisition region within the first range;
invoking, based on the region identifier corresponding to the first object, a corresponding image acquisition device to acquire an image, to obtain a second image; and
updating the visual positioning model based on the second image.

17. The electronic device of claim 16, wherein updating the visual positioning model based on the second image comprises:
performing image recognition on the second image to determine a current position of the first object; and
updating the visual positioning model based on the current position of the first object.

18. The non-transitory computer-readable storage medium of claim 10, wherein determining the path based on the first image and the visual positioning model comprises:
inputting the first image into the visual positioning model to determine a first spatial position, the first spatial position representing a mapping of an image capturing point in the three-dimensional simulation space, the first image being captured at the image capturing point;
obtaining, based on the visual positioning model, a second spatial position corresponding to the first object, the second spatial position representing a mapping of a target position in the three-dimensional simulation space, the first object being located at the target position; and
generating the path based on the first spatial position and the second spatial position.

19. The non-transitory computer-readable storage medium of claim 18, the method further comprises:
obtaining a path distance between the first spatial position and the second spatial position based on the path;
in accordance with the path distance being less than a first predetermined distance, obtaining orientation information, the orientation information representing a spatial orientation of the second spatial position relative to the first spatial position; and
playing an orientation voice corresponding to the orientation information.

20. The non-transitory computer-readable storage medium of claim 19, the method further comprises:
determining, based on the path distance, a corresponding vibration parameter, the vibration parameter representing a vibration frequency and/or a vibration amplitude; and
controlling a vibration of a vibration unit based on the vibration parameter.

21. The non-transitory computer-readable storage medium of claim 18, the method further comprises:
obtaining a second image which is an Nth image frame preceding the first image, N being an integer greater than 0;
determining image difference information based on the first image and the second image, the image difference information representing an amount of displacement of a reference object in the second image relative to the reference object in the first image;
setting an update frequency of the visual positioning model based on the image difference information; and
updating the visual positioning model based on the update frequency.

22. The non-transitory computer-readable storage medium of claim 10, the method further comprises:
obtaining a region identifier corresponding to the first object, the region identifier representing an image acquisition region within the first range;
invoking, based on the region identifier corresponding to the first object, a corresponding image acquisition device to acquire an image, to obtain a second image; and
updating the visual positioning model based on the second image.
